(19) United States
(12) Patent Application Publication
(10) Pub. No.: US 2011/0138270 A1
(43) Pub. Date: Jun. 9, 2011

(54) System of Enabling Efficient XML Compression with Streaming Support

(75) Inventors: Li Li, Beijing (CN); Qingbo Wang, Beijing (CN); Zhe Xiang, Beijing (CN); Yi Xin Zhao, Beijing (CN)

(73) Assignee: International Business Machines Corporation, Armonk, NY (US)

(21) Appl. No.: 12/916,493

(22) Filed: Oct. 30, 2010

(30) Foreign Application Priority Data
Oct. 30, 2009 (CN) 200910211379.X

(51) Int. Cl. G06F 17/00

(52) U.S. Cl. 715/242

(57) ABSTRACT

The present invention provides a method and a device for processing a structured document by steps of obtaining an access mode for a consuming party of the structured document to an element in the structured document, the element comprising tag and content; determining a compression rule based on the access mode, the compression rule specifying at least one element to be compressed and at least one element not to be compressed in the structured document; and replacing the at least one element to be compressed with a compressed element to form a compressed structured document, wherein the tag of the compressed element is a specific compression tag, and the content of the compressed element is a result of compressing the at least one element to be compressed.

### TECHNICAL FIELD

The present invention relates to the field of information processing, and more particularly, to a method and device for processing a structured document.

### DESCRIPTION OF RELATED ART

A structured document, for example a Standard Generalized Markup Language (SGML) document or an Extensible Markup Language (XML) document, is a simple data store document, and is widely used for data store and exchange. In particular, regarding the XML, its simplicity makes it very easy to load an XML document in any application and to analyze data in the XML document. In a structured document, a series of simple tags are used to identify the data as contents, and such tags may be defined and established in a convenient manner. A tag along with its identified content is called an element of the structured document.

When exchanging data with a structured document, a party generating the structured document is called the generating party, while a party loading the structured document for data analysis is called the consuming party. Typically, a structured document generated by a generating party comprises a great amount of data. A considerable network resource will be consumed for transmitting the structured document from the generating party to the consuming party. Therefore, what is desired is a solution for optimizing the generation, transmission, and consumption of a structured document.

### SUMMARY OF INVENTION

In view of the above, the present invention provides a method and device for processing a structured document, so as to provide an optimized processing method in terms of the amount of data to be transmitted and processed, and the document standardization.

A method for processing a structured document according to an embodiment of the present invention comprises:
obtaining an access mode for a consuming party of the structured document to the element in the structured document, the element comprising tag and content;
determining a compression rule based on the access mode, the compression rule specifying at least one element to be compressed and at least one element not to be compressed in the structured document; and
replacing the at least one element to be compressed with a compressed element to form a compressed structured document, wherein the tag of the compressed element is a specific compression tag, and the content of the compressed element is a result of compressing the at least one element to be compressed.

The present invention further discloses a corresponding device for processing a structured document, the device comprising:
an access mode monitor, configured to obtain the access mode of a consuming party of the structured document to the element in the structured document, the element comprising tag and content;
a compression rule decision module, configured to determine a compression rule based on the access mode, the compression rule specifying at least one element to be compressed and at least one element not to be compressed in the structured document; and
a compression execution module, configured to replace the at least one element to be compressed with a compressed element to form a compressed structured document, wherein the tag of the compressed element is a specific compression tag, and the content of the compressed element is the result of compressing the at least one element to be compressed.

According to the technical solutions of the embodiments of the present invention, an access mode about how the consuming party of the structured document accesses the structured document is used to generate the compression rule for compressing the structured document, the compression rule specifies that some of the elements in the structured document are required to be compressed, while the others are not. In general, the elements which are not required to be compressed are those used by the consuming party with relatively high frequencies. Since these elements are not compressed, the consuming party needs no performing decompression operation before using them, significantly improving the processing speed of the consuming party. Further, since the elements which are used by the consuming party with relatively low frequencies or not used at all are compressed, the network resources required for transmitting the structured document and the storage resources required for storing the document are reduced. Further, by replacing the compressed elements with newly structured elements, it can be guaranteed that the compressed structured document still complies with its specification, maintaining the advantage of simplicity and universality of a structured document.

### BRIEF DESCRIPTION OF DRAWINGS

FIG. 1 shows a block diagram of a device for processing a structured document according to an embodiment of the present invention.

FIG. 2 shows a block diagram of a device for processing a structured document according to an embodiment of the present invention.

FIG. 3 shows a block diagram of a device for processing a structured document according to an embodiment of the present invention.

FIG. 4 shows a flow chart of a method for processing a structured document according to an embodiment of the present invention.

### DETAILED DESCRIPTION OF PREFERRED EMBODIMENTS

Hereinafter, preferred embodiments of a method and a device for processing a structured document according to the present invention are illustrated with reference to the accompanying drawings. In the following description, reference will be made to XML documents as an example of structured documents. Those skilled in the art would easily understand, however, that the present solutions are also applied to any other structured document.

There are two direct solutions for reducing the network resource consumed for transmitting a structured document. One solution is to compress the whole structured document. However, before accessing the data by the consuming party, it is necessary to perform decompression operation, requiring higher processing capability of the consuming party. In particularly, in the case where real-time processing is required, decompression operations will significantly increase the processing time, thereby affecting real-time processing of data. Secondly, the consuming party cannot perform decompression operation until a complete data unit is received. For a continuous streaming type application mode where data is consumed while being generated, the generating party continuously incorporates data into the structured document, forming a data stream transmitted to the consuming party. Therefore, a complex control logic is required to segment the data stream into data units such that the corresponding compression can be carried out, increasing the complexity of both the generating and consuming parties.

The second solution is only transmitting the data that the consuming party needs to access. In general, the generating party will record many kinds of data in a structured document so as to perform a comprehensive recording, while a specific consuming party will only access one kind of data in the structured document, or access one kind of data with a relatively high frequency. However, the access mode for accessing data by the consuming party may change. Besides, the structure of a structured document might be damaged by removing a part of data from the document, such that it does not comply with the original specification any more, thereby dampening the advantages of simplicity and universality of a structured document.

Hereinafter, a solution according to a preferred embodiment of the present invention will be illustrated with reference to a specific structured document.

Refer to the following XML code segment 1, which shows a section of an XML document, where the contents between the symbol string <!—and the symbol string—> indicate the comments.

```
<!-- start of the code segment 1 -->
<SMSLog>
<SMS sender=”11111111111”>
    <sender_phone_type>......</sender_phone_type>
    <sender_cell_id>......</sender_cell_id>
    <sender_time>......</sender_time>
    <content>......</content>
  </SMS>
  <SMS sender=”22222222222”>
    <sender_phone_type>......</sender_phone_type>
    <sender_cell_id>......</sender_cell_id>
    <sender_time>......</sender_time>
    <content>......</content>
  </SMS>
  <SMS sender=”33333333333”>
    <sender_phone_type>......</sender_phone_type>
    <sender_cell_id>......</sender_cell_id>
    <sender_time>......</sender_time>
    <content>......</content>
  </SMS>
</SMSLog>
<!-- end of the code segment 1-->
```

This XML document records the sending status of short messages. The XML document is composed of elements which comprise tags and the content thereof. As shown in the code segment 1, the tag pair <SMS></SMS> and the content therebetween form an element indicating a short message record, wherein “sender=11111111111” indicates the mobile phone number of the short message sender. The tag pair <sender_phone_type></sender_phone_type> and the content therebetween is an element indicating the type of the mobile phone by which the short message is sent. The tag pair <sender_cell_id></sender_cell_id> and the content therebetween is an element indicating a base station receiving the short message, the tag pair <sender_time></sender_time> and the content therebetween is an element indicating the sending time of the short message, and the tag pair <content></content> and the content therebetween is an element indicating the content of the short message. For simplicity, the names of the tag pairs will be used to represent the respective elements hereafter. For example, reference will be made to “SMS” element, “sender_phone_type” element, “sender_cell id” element, “sender_time” element, and “content” element, etc.

It should be noted that, though the code segment 1 shows three “SMS” elements, a real XML document may comprise any number of “SMS” elements, each corresponding to a short message record. For simplicity, except for the first “SMS” element, the specific contents of the other two “SMS” elements are omitted. Further, the “sender_phone_type”, “sender_cell_id”, “sender_time”, and “content” elements in the code segment 1 are children elements of the “SMS” element, and in practice, the “SMS” element may have further other children elements.

The consuming party of the XML document containing the part as shown in the code segment 1 may be an SMS spam detection system. Only as an example, the SMS spam detection system may firstly check whether the sending number of the SMS is on a candidate list, and if not, then it is directly determined that it is not an SMS spam; otherwise, further judgment is performed based on the sending time, contents and other information of the SMS. Accordingly, for each SMS, or for each “SMS” element, the consuming party would access the data of “sender”, while the “sender_cell_id”, “sender_time”, and “content” elements will not necessarily be accessed, and the “sender_phone_type” element is even possibly not be accessed at all. According to a solution of an embodiment of the present invention, first of all, based on such access mode for the consuming party, i.e., the frequency of accessing the data of “sender” is significantly higher than the frequencies of accessing the contents in the “sender_phone type”, “sender_cell_id”, “sender_time”, and “content” elements, the “sender_phone_type”, “sender_cell_id”, “sender_time”, and “content” elements are determined as the elements to be compressed, and the data of “sender” is determined as non-compression data. Then the “sender_phone_type”, “sender_cell_id”, “sender_time”, and “content” elements are compressed. Finally, a new element is constructed to replace the positions of the “sender_phone_type”, “sender_cell_id”, “sender_time”, and “content” elements.

A code segment 2 below illustrates the part as shown by the code segment 1 after performing the replacement.

```
<!--start of the code segment 2-->
<SMSLog>
    <SMS sender=” 11111111111”>
        <ZIP-Content>......</ZIP-Content>
    </SMS>
    <SMS sender=”22222222222”>
        <ZIP-Content>......</ZIP-Content>
    </SMS>
    <SMS sender=”33333333333”>
        <ZIP-Content>......</ZIP-Content>
    </SMS>
</SMSLog>
<!-- end of the code segment 2 -->
```

The constructed new element is the tag pair <ZIP-Content></ZIP-Content> and the content therebetween. <ZIP-Content> is illustrated here as an example of compression tag. However, those skilled in the art may employ any other tag to identify the result of compressing an element to be compressed. Typically, the employed compression tag is different from the tags already used in the structured document. It can be seen from the code segment 2 that, in a processed XML document, the data of “sender” of the “SMS” element is not compressed, and therefore the consuming party is able to access the data of “sender” without performing decompression operations. In contrast, the “sender_phone_type”, “sender_cell_id”, “sender_time”, and “content” elements are all compressed. In some cases where the consuming party needs to access the content in the “sender_phone_type”, “sender_cell_id”, “sender_time”, and “content” elements, the content between <ZIP-Content></ZIP-Content> should be decompressed in advance. However, this occurs with very low frequency, and thus the additional decompression operations are acceptable in view of the reduced transmission traffic. Replacing the compressed elements with a newly constructed element may guarantee that the processed structured document still complies with the specification, thereby maintaining the characteristics of simplicity and generality of the structured document. Though merely compressing the contents between the tag pairs while maintaining the tags will likewise guarantee that the processed structured document complies with the specification, it will decrease the compression rate (i.e., the percentage of the data amount before compression over that after compression, where the larger the compression rate is, the more sufficient the compression is) since a structured document might comprise numerous tags.

A code segment 3 shows a part of another XML document.

```
<!-start of the code segment 3-->
<publication>
<book>
        <price>......</price>
<title>......</title>
        <press>......</press>
        <abstract>......</abstract>
    </book>
    <journal>
        <price>......</price>
        <title>......</title>
        <press>......</press>
        <abstract>......</abstract>
    </journal>
  <book>
        <price>......</price>
        <title>......</title>
        <press>......</press>
        <abstract>......</abstract>
    </book>
</publication>
<!-end of the code segment 3-->
```

This XML document records data of a publication. In the XML document as shown in the code segment 3, the element indicating the publication may be a “book” element or a “journal” element, both having a children element “price”. In this case, if only the access frequency of the “price” element is recorded, then the “price” element as the child of the “book” element and the “price” element as the child of the “journal” element will be processed in a same manner. However, if the consuming party only focuses on the “price” element as the child of the “book” element, then the “price” element as the child of the “journal” element should be compressed, while the “price” element as the element of the “book” element will not be compressed. At this point, besides recording the access frequency of a single element, the relationship between the single element and other elements should also be recorded with statistics calculated, in order to further distinguish whether a “price” element is a child of the “book” element or of the “journal”, thereby compressing the structured document more efficiently.

The code segment 4 below shows the part as shown in code segment 3 after being processed according to an embodiment of the present invention.

```
<!-start of the code segment 4-->
<publication>
<book”>
        <price>......</price>
<ZIP-Content>......</ZIP-Content>
    </book>
    <journal>
        <ZIP-Content>......</ZIP-Content>
    </journal>
  <book>
        <price>......</price>
        <ZIP-Content>......</ZIP-Content>
    </book>
</publication>
<!--end of the code segment 4-->
```

It should be noted that the further distinguishing here is only made based on whether a parent element of a frequently accessed element is a specific element. Those skilled in the art may understand that further distinguishing may be performed based on whether any ancestor element, any children element, or any sibling element of a frequently accessed element is a specific element. In addition, the further distinguishing may even be performed based on whether a sibling element of a parent element of a frequently accessed element is a specific element. In other words, a frequently accessed element is considered as an element not to be compressed only if this frequently accessed element has a certain relationship with a specific element.

In turn, based on whether an element has a specific relationship with the frequently accessed element, other elements not to be compressed may be determined. For example, a parent element, a children element, a sibling element and even a sibling element of the parent element of a frequently accessed element may all be considered as elements not to be compressed, despite that the parent element, the sibling element and even the sibling element of the parent element of the frequently accessed element may not be accessed or frequently accessed. Those skilled in the art would understand that determining the elements to be compressed is equivalent to determining the elements not to be compressed.

Compression rule may be used to determine the elements to be compressed based on the access mode for the consuming party, and the other elements not to be compressed. For example, for the structured document as shown in the code segment 1, the compression rule may be: the “sender_phone_type”, “sender_cell_id”, “sender_time” and “content” elements are all compressed and replaced. For the structured document as shown in the code segment 3, the compression rule may be: the “price” element as a child of the “book” element is not compressed while the “price” element as a child of the “journal” element is compressed and replaced, and the “name”, “press”, and “abstract” elements are all compressed and replaced. Besides determining the compression rules in accordance with access frequency and in accordance with the access frequency plus inter-element relationships, the compression rules may also be determined according to other criteria.

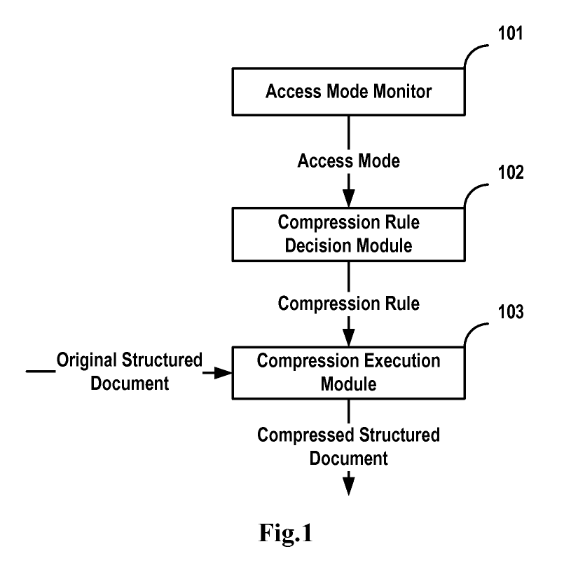

With reference to FIG. 1, a block diagram of a device for processing a structured document according to an embodiment of the present invention is shown.

As shown in FIG. 1, a device for processing a structured document according to an embodiment of the present invention comprises an access mode monitor 101, a compression rule decision module 102, and a compression execution module 103.

The access mode monitor is for obtaining an access mode for the consuming party to the structured document. There are several techniques for identifying the contents of which element(s) are accessed by the consuming party. For example, if an XML parser of the consuming party calls a specific function for accessing element content when parsing a tag, then it can be determined that the element corresponding to the tag is accessed by the consuming party. Alternatively, if the XML parser of the consuming party parses a certain tag and does not continue parsing a next tag for a long time, it may also be determined that the consuming party accesses the element corresponding to the certain tag. Based on a specification of a structured document, those skilled in the art can easily employ various means to detect which elements are accessed by the consuming party, for example, to implement a SAX probe based on org.xml.sax.helpers.DefaultHandler. Further, statistics can be calculated, for example on the access frequencies of individual elements, to obtain the mode for the consuming party relative to the structured document.

The compression rule decision module 102 determines, based on the access mode obtained by the access mode monitoring module 101, which elements shall be compressed and which elements are not to be compressed according a predetermined criterion. In other words, the compression rule decision module 102 determines the compression rule.

Based on the compression rule as determined by the compression decision module 102, the compression execution module 104 compresses the elements specified by the compression rule, and constructs a new element to replace these specified elements, the constructed new element comprising a specific compression tag and the contents obtained from the compression. Processed in such a manner, the processed document still complies with the specification of the structured document, which will not affect use of the structured document by the consuming party.

Hereinafter, the principles of respective modules will be described in detail with reference to specific examples. As previously mentioned, the predetermined criterion may be the access frequencies and/or the relationship among elements, or any other criterion. In the following example, the elements to be compressed are determined merely based on the access frequency as the criterion.

As previously mentioned, the mode for a consuming party to the elements in a structured document may change. Further, the longer the statistics are calculated on the consuming party, the more accurate access mode can be obtained. For example, “L” elements generated by the generating party at time 1 are shown below by the code segment 5:

```
<!-start of the code segment 5-->
<L> Data0
<L1>
          <L11> Data11 </L11>
          <L12> Data12 </L12>
          <L13> Data13 </L13>
      </L1>
      <L2>Data2</L2>
      <L3>
          <L31> Data31 </L31>
          <L32> Data32 </L32>
      </L3>
</L>
<!-end of the code segment 5-->
```

It should be noted that the XML code segment in the code segment 5 is only an exemplary depiction for clear and explicit expression, and in practice, the XML structure may have more layers, and the content of each element may be longer. Further, other structured documents may have other forms.

When the system starts working, assuming there is no default compression rule available at this time, since the system has no knowledge about the access mode for any consuming party, the compression rule set will be null, i.e., the compression execution module 103 will not perform compression on the XML document. The XML document is directly transmitted to the consuming party from the generating party for access by the consuming party.

Compress_Set={ } (1)

As the consuming party is accessing the structured document, the access mode monitor 101 detects, through analyzing the access mode for the consuming party, that the frequencies of accessing the “L2” and “L3” elements are significantly lower than the frequency of accessing the “L1” element by the consuming party, or the “L2” and “L3” elements are not accessed at all. Thereby, on the basis of access frequency as criterion, the compression rule decision module 102 generates a new compression rule:

Compress_Set={L2,L3} (2)

Thus, the compression rule drives the compression execution module 103, such that the “L” element generated at time 2 is as shown by the following code segment 6:

```
<!-start of the code segment 6-->
<L> Data0
<L1>
          <L11> Data11 </L11>
          <L12> Data12 </L12>
          <L13> Data13 </L13>
      </L1>
      <ZIP-Content>ZippedData1</ZIP-Content>
</L>
<!-end of the code segment 6-->
```

where the content “ZippedData1” is a result of compressing the following elements:

```
<L2>Data2</L2>
      <L3>
          <L31> Data31 </L31>
          <L32> Data32 </L32>
      </L3>
```

Further, as the consuming party continues working, the access mode monitor 101 detects that the frequencies of accessing the “L11”, “L12”, and “L13” elements are also with significant difference, where the frequency of accessing “L11” is far higher than accessing “L12” and “L13”. The compression rule decision module 102 updates the compression rule, such that:

Compress_Set={L2,L3,L11,L13} (3)

Driven by this compression rule, the “L” element generated by the compression execution module 103 at time 3 is as shown by the code segment 7:

```
<!-start of the code segment 7-->
<L> Data0
<L1>
        <L11> Data11 </L11>
        <ZIP-Content> ZippedData2</ZIP-Content>
    </L1>
    <ZIP-Content> ZippedData1</ZIP-Content>
</L>
<!-end of the code segment 7-->
```

where the content “ZippedData1” is a result of compressing the following elements:

<L12> Data12 </L12>
<L13> Data13 </L13>

Accordingly, by calculating statistics through constantly observing the mode for the consuming party to the elements in the structured document, the compression rule is updated constantly. Of course, the above only illustrates the example where the frequency of accessing a single element is used as the criterion. As previously mentioned, if different elements have children elements with identical names, the relationships between the single element and other elements may be further considered.

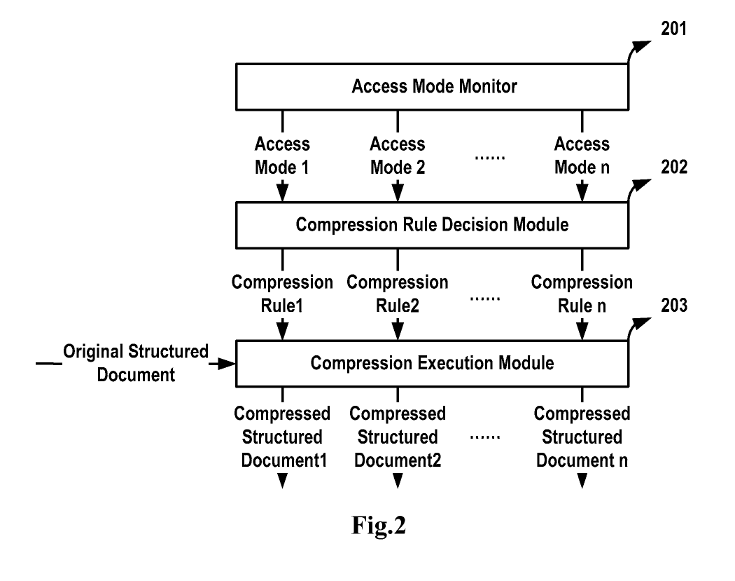

The above is only directed to the case of a single consuming party. In practice, a structured document generated by the generating party may be required to be transmitted to a plurality of consuming parties, and the access modes for respective consuming parties may be different. For example, a consuming party A of the code segment 1 needs to access the “content” element, while a consuming party B of the code segment 1 needs to access the “sender_phone_type” element. According to an embodiment of the present invention, the access mode monitor 201 obtains the access modes for respective consumers, the compression rule decision module 202 determines different compression rules based on these access modes, and then the compression execution module 203 processes the original structured document based on different compression rules to obtain different compressed structured documents for respective consumers. FIG. 2 shows a block diagram of a device for processing a structured document according to the embodiment.

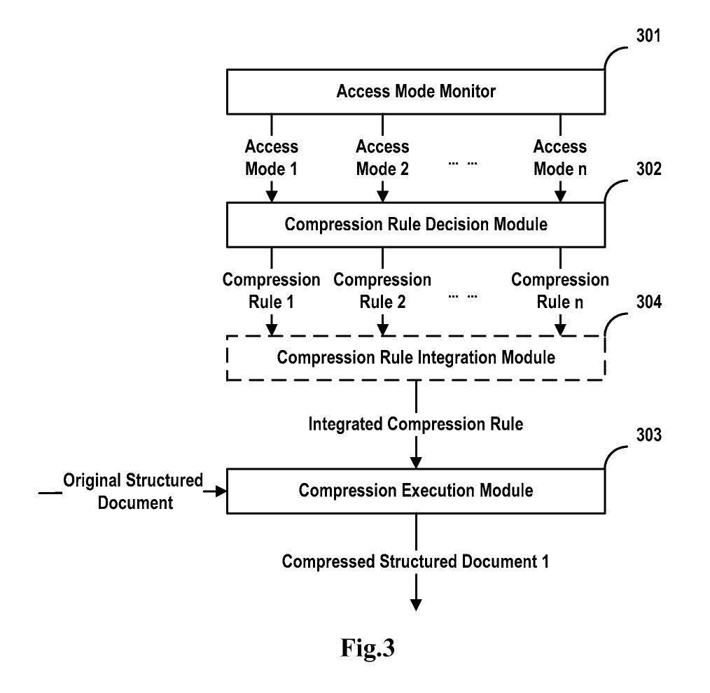

A block diagram of a device for processing a structured document according to another embodiment of the present invention is shown in FIG. 3. The device for processing a structured document according to the embodiment further comprises a compression rule integration module 304, for integrally optimizing the plurality of compression rules generated by the compression rule decision module, in order to form a single compression rule. Continuing the above scenario as an example, with respect to the access mode for the consuming party, the compression rule decision module 302 generates a compression rule: compressing the “sender_phone_type”, “sender_cell_id”, and “sender_time” elements. With respect to the access mode for the consuming party B, the compression rule decision module 302 generates another compression rule: compressing the “sender_phone_type”, “sender_cell_id”, “sender_time”, and “content” elements. The compression rule integration module 304 integrates and optimizes the two compression rules as follows: compressing the “sender_cell_id” and “sender_time” elements. Those skilled in the art may employ other policies to integrate and optimize a plurality of compression rules to thereby generate an integrated compression rule.

Compared with the embodiment as shown in FIG. 2, the integrated compression rule enables providing a single compressed structured document to a plurality of consuming parties having different access modes, though the integrated rules might not an optimal compression rule for some individual consuming parties.

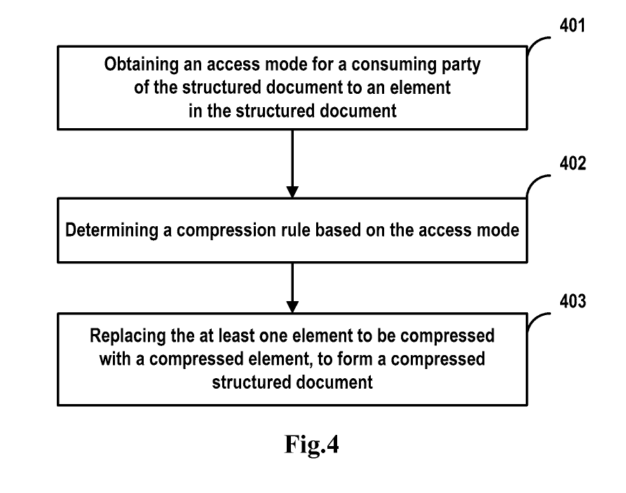

FIG. 4 shows a flow chart of a method for processing a structured document according to an embodiment of the present invention. This method comprises:
obtaining an access mode for a consuming party of the structured document to an element in the structured document by, the element comprising tag and content;
determining a compression rule based on the access mode, the compression rule specifying at least one element to be compressed and at least one element not to be compressed in the structured document; and
replacing the at least one element to be compressed with a compressed element in the structured document, wherein the tag of the compressed element is a specific compression tag, and the content of the compressed element is a result of compressing the element to be compressed.

As previously mentioned, different criteria may be used to determine compression rules based on access mode. With reference to the code segments 1 and 2, the elements in a structured document may be classified as elements to be compressed and elements not to be compressed based on access frequencies by the consuming party. With reference to code segments 3 and 4, the ancestor elements and/or children elements of an element may be further distinguished, and the elements in the structured document may be classified as elements to be compressed and elements not to be compressed based on whether there are specified ancestor elements and/or children elements.

Further, as shown in the code segments 5-7, an updated access mode may be obtained, and the compression rule may be re-determined based on the updated access mode.

For the circumstances where there are pluralities of consuming parties having different access modes, a compression policy may be generated for each consuming party, respectively. Based on different compression policies, integration and optimization may be performed on the respective plurality of compression rules, respectively, thereby obtaining a single compression rule.

Those normally skilled in the art may understand that the above method and system may be implemented with a computer-executable instruction and/or in a processor controlled code, for example, such code is provided on a storage medium such as a magnetic disk, CD, or DVD-ROM, or a programmable memory such as a read-only memory (firmware). The system and its components for controlling energy consumption of a mobile device in the present embodiment may be implemented by hardware circuitry of a programmable hardware device such as a very large scale integrated circuit or gate array, a semiconductor such as logical chip or transistor, or a field-programmable gate array, or a programmable logical device, or implemented by software executed by various kinds of processors, or implemented by combination of the above hardware circuitry and software.

Though a plurality of exemplary embodiments of the present invention have been illustrated and depicted, those skilled in the art would appreciate that without departing from the principle and spirit of the present invention, change may be made to these embodiments, and the scope of the present invention is limited by the appending claims and equivalent variation thereof.

What is claimed is:

1. A method for processing a structured document, comprising:
obtaining an access mode about how a consuming party of the structured document accesses an element in the structured document, the element comprising tag and content;
determining a compression rule based on the access mode, the compression rule specifying at least one element to be compressed and at least one element not to be compressed in the structured document; and
replacing the at least one element to be compressed with a compressed element to form a compressed structured document, wherein a tag of the compressed element is a specific compression tag, and content of the compressed element is a result of compressing the at least one element to be compressed.

2. The method according to claim 1, wherein determining the compression rule based on the access mode comprises:
determining frequencies of accessing elements in the structured document by the consuming party; and
classifying the elements in the structured document as elements to be compressed and elements not to be compressed based on the frequencies of accessing by the consuming party.

3. The method according to claim 2, wherein classifying the elements in the structured document as the elements to be compressed and the elements not to be compressed based on the frequencies of accessing by the consuming party comprises:
determining elements which are frequently accessed by the consuming party and have a specific relationship with a specific element as the elements not to be compressed.

4. The method according to claim 2, wherein classifying the elements in the structured document as the elements to be compressed and the elements not to be compressed based on the frequencies of accessing by the consuming party comprises:
determining elements, which have a specific relationship with a specific element frequently accessed by the consuming party, as the elements not to be compressed.

5. The method according to claim 3, wherein classifying the elements in the structured document as the elements to be compressed and the elements not to be compressed based on the frequencies of accessing by the consuming party comprises:
determining elements, which have a specific relationship with a specific element frequently accessed by the consuming party, as the elements not to be compressed.

6. The method according to claim 1, further comprising:
obtaining an updated access mode, and re-determining the compression rule based on the updated access mode.

7. The method according to claim 1, further comprising:
integrating and optimizing a plurality of compression rules corresponding to a plurality of consuming parties having different access modes, respectively, to obtain a single integrated compression rule.

8. A device for processing a structured document, comprising:
an access mode monitor, configured to obtain an access mode about how a consuming party of the structured document accesses an element in the structured document, the element comprising tag and content;
a compression rule decision module, configured to determine a compression rule based on the access mode, the compression rule specifying at least one element to be compressed and at least one element not to be compressed in the structured document; and
a compression execution module, configured to replace the at least one element to be compressed with a compressed element to form a compressed structured document, wherein the tag of the compressed element is a specific compression tag, and the content of the compressed element is a result of compressing the at least one element to be compressed.

9. The device according to claim 8, wherein the compression rule decision module comprises:
a module configured to determine the frequencies of accessing elements in the structured document by the consuming party based on the access mode; and
a module configured to classify the elements in the structured document as elements to be compressed and elements not to be compressed based on the frequencies of accessing by the consuming party.

10. The device according to claim 9, wherein the module configured to classify the elements in the structured document as the elements to be compressed and the elements not to be compressed based on the frequencies of accessing by the consuming party comprises:
a module configured to determine elements, which are frequently accessed by the consuming party and have a specific relationship with a specific element, as the elements not to be compressed.

11. The device according to claim 9, wherein the module configured to classify the elements in the structured document as the elements to be compressed and the elements not to be compressed based on the frequencies of accessing by the consuming party comprises:
a module configured to determine elements, which have a specific relationship with a specific element frequently accessed by the consuming party, as the elements not to be compressed.

12. The device according to claim 10, wherein the module configured to classify the elements in the structured document as the elements to be compressed and the elements not to be compressed based on the frequencies of accessing by the consuming party comprises:
a module configured to determine elements, which have a specific relationship with a specific element frequently accessed by the consuming party, as the elements not to be compressed.

13. The device according to claim 8, wherein the access mode monitor is further configured to obtain an updated access mode, and wherein the compression rule decision module is further configured to re-determines the compression rule based on the updated access mode.

14. The device according to claim 8, further comprising:
a compression rule integration module, configured to integrate and optimize a plurality of compression rules corresponding to a plurality of consuming parties having different access modes, respectively, to obtain a single integrated compression rule.
